(19) United States
(12) Patent Application Publication
(10) Pub. No.: US 2002/0167914 A1
(43) Pub. Date: Nov. 14, 2002

(54) Node detecting method, node detecting apparatus and node detecting program

(76) Inventor: Jun Haneda, Tokyo (JP)

Correspondence Address: RYUKA, 1-24-12 SHINJUKU, SIXTH FLOOR, TOSHIN BUILDING, SHINJUKU-KU, TOKYO, 160-0022, JP

(21) Appl. No.: 09/682,504

(22) Filed: Sep. 10, 2001

(30) Foreign Application Priority Data
May 10, 2001 (JP) 2001-140614

(51) Int. Cl. H04L 12/28

(52) U.S. Cl. 370/255; 370/386

(57) ABSTRACT

A node detecting method for detecting a node that operates as a device in a computer network, comprises: a first transmitting step of transmitting a first detection signal to the node; a first receiving step of receiving, from the node that received the first detection signal, address information of the node; a first storing step of storing in a first memory the address information of the node received in the first receiving step; a second transmitting step of transmitting a second detection signal to the node by using the address information of the node stored in the first memory; a second receiving step of receiving, from the node that received the second detection signal, classification information of the node in response to the second detection signal; a judging step of judging a classification of the node based on the classification information of the node received in the second receiving step; and a second storing step of storing the classification information of the node in a second memory to correspond to the classification of the node.

### CROSS REFERENCE TO RELATED APPLICATIONS

This patent application claims priority based on a Japanese patent application, 2001-140614 filed on May 10, 2001, the contents of which are incorporated herein by reference.

### BACKGROUND OF INVENTION

1. Field of the Invention

The present invention relates to a node detecting method, a node detecting apparatus and a node detecting program. More particularly, the present invention relates to detecting a node that is a device included in a computer network.

2. Description of the Related Art

In administration of a computer network, it is important to precisely find information regarding nodes which are devices configuring the computer network. Thus, an administration system that can automatically find the nodes configuring the computer network is used. For example, a node detecting method for use in a network that is configured by nodes having MAC addresses and IP addresses is disclosed in Japanese Patent Application Laying-Open No. 6-338884 (published on Dec. 6, 1995).

According to the node detecting method disclosed in the aforementioned Japanese patent application, a node is detected based on its IP address. Thus, it is difficult to detect a node having no IP address. Moreover, a switching hub does not have the IP address of the node connected to a port thereof. Thus, it is difficult to precisely detect the configuration of the computer network including the switching hub.

### SUMMARY OF INVENTION

Therefore, it is an object of the present invention to provide a node detecting method, a node detecting apparatus and a node detecting program, which are capable of overcoming the above drawbacks accompanying the conventional art. The above and other objects can be achieved by combinations described in the independent claims. The dependent claims define further advantageous and exemplary combinations of the present invention.

According to the first aspect of the present invention, a node detecting method for detecting a node that operates as a device in a computer network, comprising: a first transmitting step of transmitting a first detection signal to the node; a first receiving step of receiving, from the node that received the first detection signal, address information of the node; a first storing step of storing in a first memory the address information of the node received in the first receiving step; a second transmitting step of transmitting a second detection signal to the node by using the address information of the node stored in the first memory; a second receiving step of receiving, from the node that received the second detection signal, classification information of the node in response to the second detection signal; a judging step of judging a classification of the node based on the classification information of the node received in the second receiving step; and a second storing step of storing the classification information of the node in a second memory to correspond to the classification of the node.

The first transmitting step may include transmitting an ICMP echo message as the first detection signal to a plurality of nodes by using a broadcast address of a predetermined subnet, the first receiving step may include receiving, from at least one of the plurality of nodes that responds to the ICMP echo message, an IP address thereof as the address information, and the first storing step may include storing the IP address of the at least one node.

The second transmitting step may include transmitting an ICMP echo message as the second detection signal to the node based upon the address information stored in the first memory, the second receiving step may include receiving, from the node that responds to the ICMP echo message, an IP address of the node as the classification information, the judging step may include judging that the node that sent the IP address is an IP node, and the second storing step may include storing the node as the IP node to correspond to the IP address.

The first receiving step may include receiving from the node an MAC address of the node, the second transmitting step may include transmitting an ICMP echo message as the second detection signal to the node stored in the first memory, the judging step may include judging that the node that received the ICMP echo message is a MAC node when there is no response from the node that received the ICMP echo message, and the second storing step may include storing the node as the MAC node to correspond to the MAC address.

The second transmitting step may further include transmitting a detection signal according to an SNMP protocol to the node based upon the address information stored in the first memory, the second receiving step may include receiving, from the node that received the detection signal according to the SNMP protocol, SNMP information of the node, the judging step may include judging that the node that sent the SNMP information is an SNMP node, and the second storing step may include storing the node as the SNMP node to correspond to the SNMP information.

The judging step may include judging based on the SNMP information whether or not the node is an interconnecting device, and the second storing step may include storing the node as an interconnecting node to correspond to the SNMP information, when the node is judged to be the interconnecting device in the judging.

The node detecting method may further comprise: a third receiving step of receiving, from the interconnecting node, port identifying information for identifying a port of the interconnecting node and node identifying information of a node connected to the port; and a third storing step of storing the node identifying information of the node connected to the port in the second memory to correspond to the port identifying information of the port to which the node is connected.

In a case where the interconnecting node has a stack connection, the third receiving step may include receiving, from the interconnecting node, stack identifying information for identifying a stack of the interconnecting node and the node identifying information of the node connected to the stack, and the third storing step may include storing the node identifying information of the node connected to the stack in the second memory to correspond to the stack identifying information received in the third receiving step.

In a case where a VLAN group is set to the port of the interconnecting node, the third receiving step may include receiving, from the interconnecting node, VLAN identifying information for identifying the VLAN group and the node identifying information for identifying the node that belongs to the VLAN group, and the third storing step may include storing the node identifying information of the node that belongs to the VLAN group in the second memory to correspond to the VLAN identifying information received in the third receiving step.

The node detecting method further comprise: a third receiving step of receiving address information of a node connected to the interconnecting node from the interconnecting node; a third storing step of storing in the first memory the address information of the node received in the third receiving step; and repeating the second transmitting step, the second receiving step, the judging step, the second storing step, the third receiving step and the third storing step for the node connected to the interconnecting node.

In the third storing step, node identifying information of the node connected to the interconnecting node may be stored in the second memory to correspond to the interconnecting node.

The node detecting method may further comprise: determining a weight of a node being detected in advance depending on the classification of the node being detected, comparing a first weight of the node being detected having the classification based upon the classification information received in the second receiving step and a second weight of the node being detected having a previous classification stored in the second memory, merging node identifying information of the node having less weight based upon the comparing into node identifying information of the node having more weight, and storing the merged node identifying information in the second memory to correspond to the classification of the node having more weight.

The weight may be determined in such a manner that the weight corresponding to each of the MAC node, the IP node, the SNMP node and the interconnecting node increases in that order.

According to the second aspect of the present invention, a node detecting apparatus for detecting a node that operates as a device in a computer network, comprising: a transmitting unit operable to transmit a first detection signal to the node; a receiving unit operable to receive, from the node that received the first detection signal, address information of the node; a first memory operable to store the address information of the node received by the receiving unit; a judging unit operable to transmit a second detection signal to the node based on the address information of the node stored in the first memory, and to judge, in a case where classification information of the node is received from the node in response to the second detection signal, a classification of the node based on the classification information of the node; and a second memory operable to store the classification information of the node to correspond to the classification of the node.

According to the third aspect of the present invention, a node detecting program for detecting a node that operates as a device in a computer network, comprising: a transmitting module operable to transmit a first detection signal to the node; a receiving module operable to receive, from the node that received the first detection signal, address information of the node; a first storing module operable to store the received address information of the node; a judging module operable to transmit a second detection signal to the node based on the address information of the node stored in the first memory, and to judge, in a case where classification information of the node is received from the node in response to the second detection signal, a classification of the node based on the classification information of the node; and a second storing module operable to store the classification information of the node to correspond to the classification of the node.

The summary of the invention does not necessarily describe all necessary features of the present invention. The present invention may also be a sub-combination of the features described above. The above and other features and advantages of the present invention will become more apparent from the following description of the embodiments taken in conjunction with the accompanying drawings.

### BRIEF DESCRIPTION OF DRAWINGS

FIG. 1 shows a configuration of a computer network according to an embodiment of the present invention.

FIG. 2 shows a structure of a node detecting apparatus according to the embodiment of the present invention.

FIG. 3 shows an exemplary data format of an address-list file stored in the first memory of the node detecting apparatus according to the embodiment of the present invention.

FIG. 4 shows an exemplary data format of an object file stored in the second memory of the node detecting apparatus according to the embodiment of the present invention.

FIGS. 5A to 5C are flowcharts of a node detecting method according to the embodiment of the present invention.

FIG. 6 shows an exemplary hardware configuration of the node detecting apparatus.

### DETAILED DESCRIPTION

The invention will now be described based on the preferred embodiments, which do not intend to limit the scope of the present invention, but exemplify the invention. All of the features and the combinations thereof described in the embodiment are not necessarily essential to the invention.

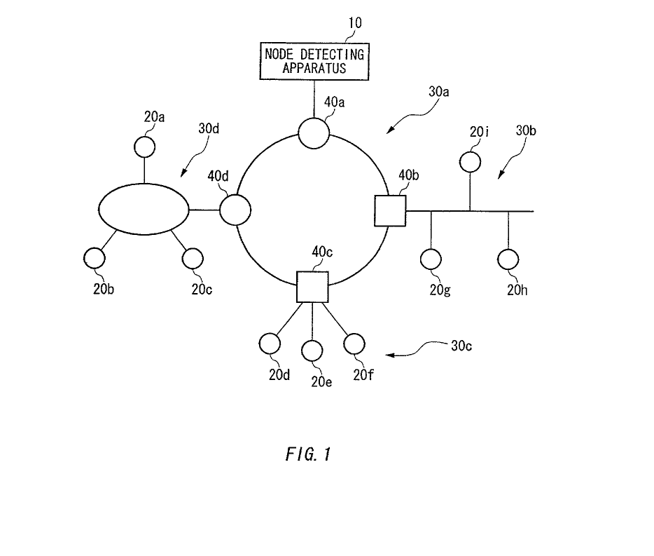

FIG. 1 shows an exemplary configuration of a computer network according to an embodiment of the present invention. The computer network of the present embodiment includes a node detecting apparatus 10 that can detect a node that is a device included in the computer network system, communication devices 20a to 20i that can perform communication in the computer network system, and interconnecting devices 40a to 40d that can interconnect the communication between the node detecting apparatus 10 and the communication devices 20a to 20i. The interconnecting devices 40a to 40d may be switching hubs each of which stores a MAC address of the node connected thereto or routers each of which stores the MAC address and IP address of the node connected thereto.

The computer network system of the present embodiment includes subnets 30a, 30b, 30c and 30d. The node detecting apparatus 10 performs a node detecting operation for each of the subnets 30a to 30d. For example, the node detecting operation is first performed for the subnet 30a, and a network address of the subnet 30a is obtained in that node detecting operation. Then, the node detecting operation is performed for the subnet 30b. According to the node detecting apparatus 10 of the present embodiment, the nodes of the computer network can be detected by identifying one of the network addresses of the subnets included in the computer network.

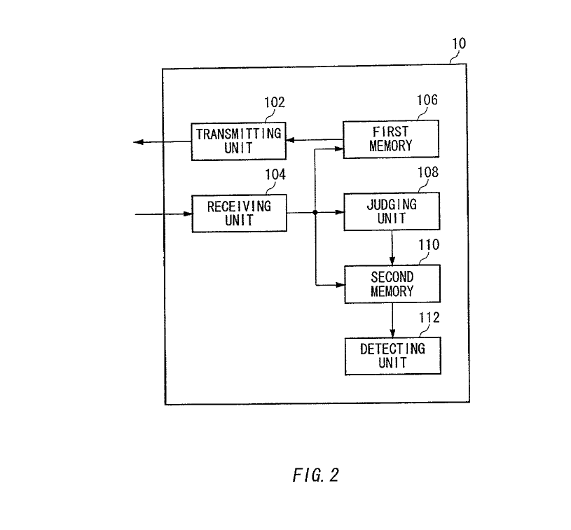

FIG. 2 shows a structure of the node detecting apparatus 10 of the present embodiment. The node detecting apparatus 10 of the present embodiment includes a transmitting unit 102 that can transmit a detection signal to a node included in the computer network, a receiving unit 104 that can receive information sent from the node of the computer network, a first memory 106 and a second memory 110 that can store information received by the receiving unit 104, a judging unit 108 that can judge, based on the information received by the receiving unit 104, a classification of the node that sent that information, and a detecting unit 112 that can detect the configuration of the computer network based on the information stored in the second memory 110.

The transmitting unit 102 transmits a first detection signal to a node included in the computer network. The receiving unit 104 then receives, from the node that received the first detection signal, address information of that node. The first memory 106 stores the address information of the node received by the receiving unit 104. Next, the transmitting unit 102 transmits a second detection signal to the node based on the address information of the node stored in the first memory 106. The receiving unit 104 then receives, from the node that received the second detection signal, classification information of the node in response to the second detection signal. The judging unit 108 judges the classification of the node based on the classification information of the node. Then, the second memory 110 stores the classification information of the node corresponding to the classification of the node. Finally, the detecting unit 112 detects the configuration of the computer network based on the classification information of the node stored in the second memory 110.

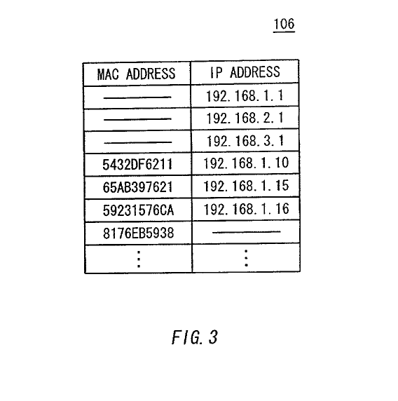

FIG. 3 shows a data format of an address-list file stored in the first memory 106. The address-list file has a MAC (Media Access Control) address field and an IP address field. The MAC address field and the IP address field respectively store a MAC address and an IP address of a node included in the computer network.

In the node detecting method of the present embodiment, the transmitting unit 102 transmits an ICMP (Internet Control Message Protocol) echo message as the first detection signal to a plurality of nodes by using a broadcast address of a predetermined subnet. The receiving unit 104 then receives, from the node that responds to the ICMP echo message, the IP address of that node. In this case, the first memory 106 stores the IP address received by the receiving unit 104. The receiving unit 104 also receives from an interconnecting device included in the computer network address information regarding the address of the node connected to that interconnecting device. More specifically, in a case where the interconnecting device is a router, the receiving unit 104 receives an IP address and a MAC address that the router has. The first memory 106 stores the IP address and the MAC address received by the receiving unit 104. In another case where the interconnecting device is a switching hub, the receiving unit 104 receives the MAC address that the switching hub has. The first memory 106 then stores the MAC address received by the receiving unit 104.

The node detecting apparatus 10 obtains the classification information of the node by transmitting the second detection signal to the node that has the MAC address and/or IP address stored in the first memory 106. The node detecting apparatus 10 obtains the classification information for all the nodes included in the computer network, thereby detecting the configuration of the computer network based on the classification information of the nodes. According to the node detecting apparatus 10 of the present embodiment, the classification of the node is detected by transmitting the second detection signal to the node having the MAC address held by the switching hub. Thus, it is possible to precisely detect the configuration of the computer network including the switching hub.

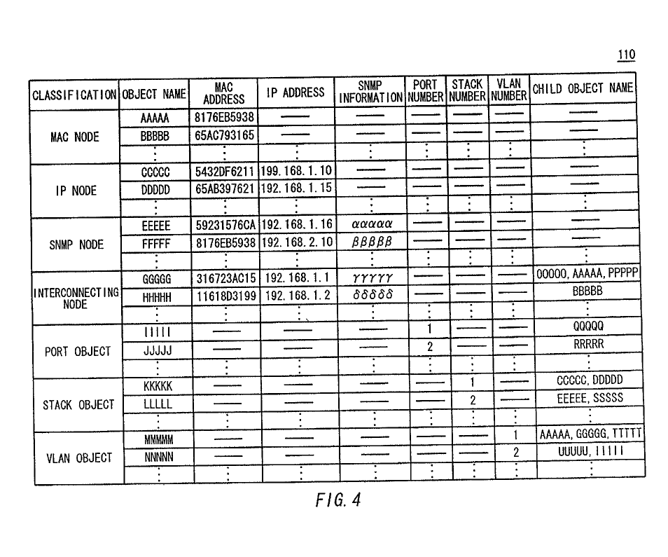

FIG. 4 shows a data format of an object file stored in the second memory 110. The object file has a classification field, an object-name field, a MAC address field, an IP address field, an SNMP information field, a port number field, a stack number field, a VLAN number field and a child-object-name field. The classification field stores a classification of a node or object. More specifically, the classification field can store, as the classification, a MAC node, an IP node, an SNMP node, an interconnecting node, a port object, a stack object and a VLAN object. The MAC node is a node that does not respond to the ICMP echo message, whereas the IP node is a node that responds to the ICMP echo message. The SNMP node is a node corresponding to an SNMP protocol. The interconnecting node is a node serving as an interconnecting device having a plurality of ports. The port object is an object assigned to each of the ports of the interconnecting device. The stack object is an object assigned to each of the interconnecting devices connected to each other in a stacking manner. The VLAN object is an object assigned to each of the VLAN groups.

The object-name field stores an object name independently provided for each of the nodes and objects. The MAC address field can store the MAC address of the MAC node, IP node, SNMP node or interconnecting node. The IP address field stores the IP address of the IP node, SNMP node or interconnecting node. The SNMP information field stores the SNMP information the SNMP node has. The port number field stores a port number that is an example of port identifying information for identifying a port object. The stack number field stores a stack number that is an example of stack identifying information for identifying a stack object. The VLAN number field stores a VLAN number that is an example of VLAN identifying information for identifying a VLAN group.

The child-object-name field stores the object names of one or more nodes or objects associated with each node or object. For example, the child-object-name field for a particular interconnecting node stores the object name of the MAC node, IP node, SNMP node and interconnecting node that are connected to ports of the particular interconnecting node, the object name of the port object of the port of the particular interconnecting node, and the object name of the stack object of the stack that the particular interconnecting node has. The child-object-name field for a particular port object stores the object names of the MAC node, IP node, SNMP node and interconnecting node that are connected to the particular port object. The child-object-name field for a particular stack object stores the object names of the MAC node, IP node, SNMP node and interconnecting node that are connected to the particular stack object. The child-object-name field for a particular VLAN object stores the object names of the MAC node, IP node, SNMP node and interconnecting node that belong to the VLAN group of the particular VLAN object.

The node detecting apparatus 10 of the present embodiment stores the MAC node, the IP node, the SNMP node, the interconnecting node, the port object, the stack object and the VLAN object in the common data format. Thus, the node detecting apparatus 10 of the present embodiment can easily administrate the devices included in the computer network. In a case of setting a desired node or object, it is possible to search the desired node or object in all the nodes or objects by using the object name as a search key. Moreover, it is possible to simply perform the detail setting of the devices included in the computer network by creating the port object, the stack object and the VLAN object.

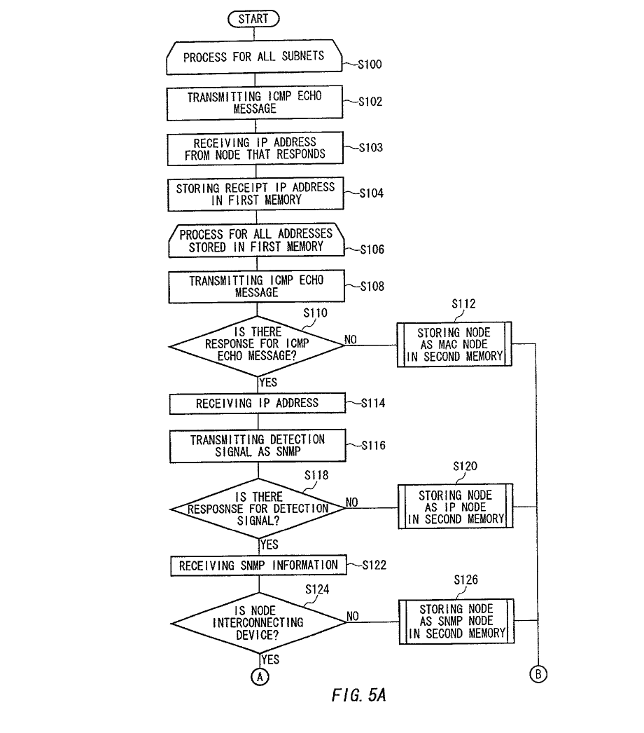

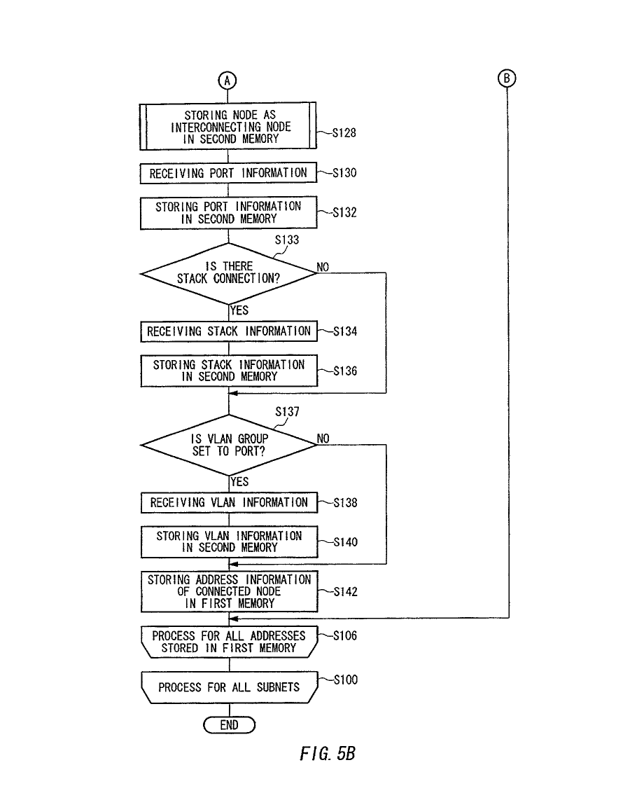

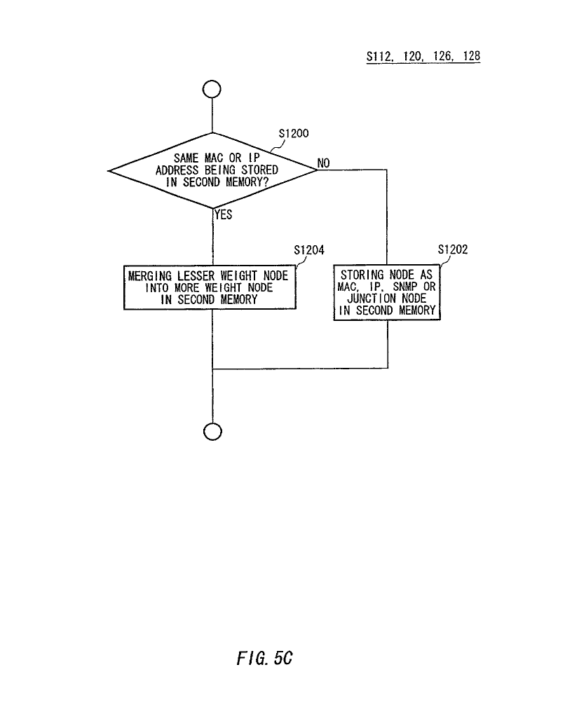

FIGS. 5A to 5C are flowcharts of a node detecting method according to the present embodiment. The node detecting apparatus 10 performs operations of Steps S102 to S142 described below in a subnet which is identified in advance and in a subnet which is detected in that node detecting operation (Step S100). First, the transmitting unit 102 transmits an ICMP echo message as the first detection signal to a plurality of nodes by using a broadcast address of the subnet (Step S102). The receiving unit 104 then receives, from the node that responds to the ICMP echo message, the IP address and MAC address thereof (Step S103). The first memory 106 stores the IP address and MAC address received by the receiving unit 104 (Step S104).

Next, the node detecting apparatus 10 performs the operations of Steps S108 to S142 for the node having the MAC address and/or IP address stored in the first memory 106 (Step S106). First, the transmitting unit 102 transmits an ICMP echo message as the second detection signal for the node stored in the first memory 106 (Step S108). In a case where there is no response to the ICMP echo message transmitted in Step S108 and the node to which the ICMP echo message was transmitted is stored in the first memory 106, the judging unit 108 judges that the node that received the ICMP echo message is an MAC node (Step S110). Then, the second memory 110 stores that node as the MAC node so as to correspond to the MAC address thereof (Step S112). The node detecting apparatus 10 performs the operations of Step S108 and subsequent steps for the node having the next MAC address and/or IP address stored in the first memory 106.

In a case where there is a response to the ICMP echo message transmitted in Step S108, the receiving unit 104 receives, from the node that responded to the ICMP echo message, the IP address of that node (Step S114). Then, the transmitting unit 102 transmits a detection signal according to the SNMP protocol to the node that responded to the ICMP echo message (Step S116). In a case where there is no response to the detection signal according to the SNMP protocol transmitted in Step S116, the judging unit 108 judges that the node that received the detection signal according to the SNMP protocol is an IP node (Step S118). The second memory 110 then stores that node as the IP node so as to correspond to the IP address thereof (Step S120). The node detecting apparatus 10 then performs the operations of Step S108 and the subsequent steps for the node having the next MAC address and/or IP address stored in the first memory 106.

In a case where there is a response to the detection signal according to the SNMP protocol that the transmitting unit 102 transmitted in Step S116, the receiving unit 104 receives, from the node that responded to the detection signal according to the SNMP protocol, SNMP information of that node (Step S122). The judging unit 108 then judges based on the received SNMP information whether or not the node which sent that SNMP information is an interconnecting device (Step S124). When it is not judged that the node that sent the SNMP information is an interconnecting device in Step S124, the second memory 110 stores the node which sent the SNMP information as an SNMP node so as to correspond to the SNMP information (Step S126). Then, the node detecting apparatus 10 performs the operations of Step S108 and the subsequent steps for the node having the next MAC address and/or IP address stored in the first memory 106.

When the judging unit 108 judged in Step S124 that the node that sent the SNMP information is the interconnecting device, the second memory 110 stores the node that sent the SNMP information as an interconnecting node so as to correspond to the SNMP information (Step S128). The receiving unit 104 then receives, from the interconnecting node that sent the SNMP information, the port numbers of the ports of that interconnecting node and node identifying information of the nodes connected to the ports (Step S130). The second memory 110 stores the port number of each port and the node identifying information of the node connected to the port, that were received by the receiving unit 104, so as to correspond to the object name of the port (Step S132).

Next, in a case where the interconnecting node has a stack connection (Step S133), the receiving unit 104 receives from the interconnecting node the stack number that the interconnecting node has and the node identifying information of the node connected to the stack (Step S134). The second memory 110 then stores the stack number and the node identifying information that were received by the receiving unit 104, so as to correspond to the object name of the stack (Step S136).

Then, in a case where there is a VLAN group set to the port of the interconnecting node (Step S137), the receiving unit 104 receives from the interconnecting node the VLAN number that identifies the VLAN group and the node identifying information of the node that belongs to that VLAN group (Step S138). The second memory 110 then stores the VLAN number of the VLAN group and the node identifying information of the node that belongs to that VLAN group, that were received by the receiving unit 104, so as to correspond to the object name of the VLAN group (Step S140). Moreover, the first memory 106 stores the node identifying information of the node connected to each port that was received by the receiving unit 104 in Step S130 (Step S142).

The node detecting apparatus 10 performs the operations of Step S108 and the subsequent steps for the node having the next MAC address or IP address stored in the first memory 106. When the operations for detecting nodes have been done for all the MAC addresses and/or IP addresses stored in the first memory 106, the node detecting apparatus 10 performs the operations of Step S102 and the subsequent steps for the next subnet detected in the above-described node detecting operation.

It should be noted that the MAC node, the IP node, the SNMP node and the interconnecting node are determined in advance to have corresponding weights that increase in that order. Thus, when the second memory 110 stores the MAC node, the IP node, the SNMP node and the interconnecting node in each of Steps S112, S120, S126, and S128, the second memory 110 confirms whether or not the same MAC and/or IP address of the node, which was actually received by the receiving unit 104, has already been stored in the second memory 110 (S1200) (note FIG. 5C). In the case that the same MAC and/or IP address has not been stored in the second memory 110, the second memory stores the node, which was actually received by the receiving unit 104, as a MAC, IP, SNMP or interconnecting node (S1202). On the other hand, in the case that the same MAC and/or IP address has already been stored in the second memory 110, the second memory 110 performs an operation for merging the node information for the classification of the node that was actually received by the receiving unit 104 and the classification stored to correspond to the information of the node already stored in the second memory 110 (S1204). More specifically, in this merging operation (S1204), the weight of the node, which was actually received by the receiving unit 104, is compared with that of the node, which has already been stored in the second memory 110. Then, the node information of the node having lesser weight is merged into the node information of the node having more weight. Then, the second memory 110 stores the merged node information to correspond to the classification of the node having more weight.

According to the node detecting method of the present embodiment, the MAC node, the IP node, the SNMP node, the interconnecting node, the port object, the stack object and the VLAN object are stored in the commonly determined data format. Thus, it is possible to easily administrate the devices included in the computer network. Moreover, the detail setting of devices included in the computer network can be simply performed by creating the port object, the stack object and the VLAN object. Furthermore, the operation for detecting the node classification is performed for the node that is connected to a switching hub, as an example of the interconnecting device, and that has the MAC address that was obtained as the port information of that switching hub. Thus, the classification of the node included in the computer network having the switching hub can be detected precisely.

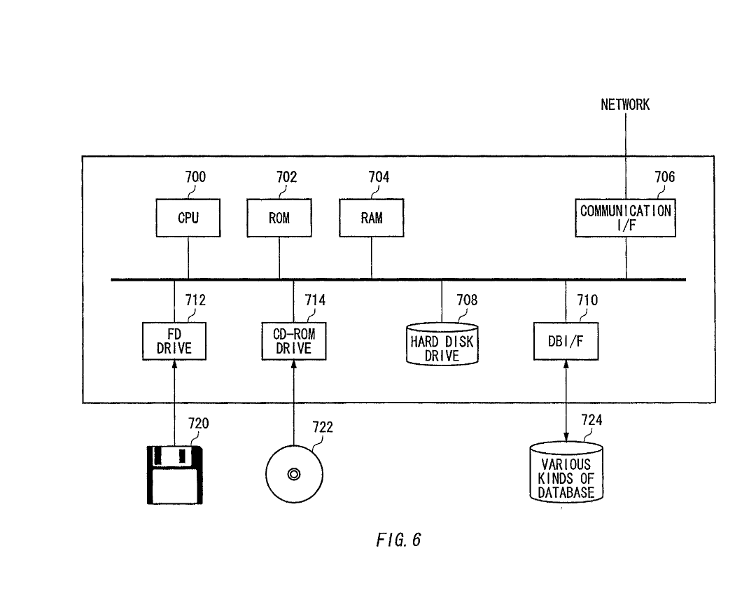

FIG. 6 shows an exemplary hardware configuration of the node detecting apparatus 10. The node detecting apparatus 10 includes a CPU 700, a ROM 702, a RAM 704, a communication interface 706, a hard disk drive 708, a database interface 710, a floppy disk drive 712 and a CD-ROM drive 714. The CPU 700 operates based on at least one program stored in the ROM 702 and RAM 704. The communication interface 706 allows the communication with a network administration apparatus through the network. The database interface 710 writes data into a database and updates the contents of the database. The hard disk drive 708, that is an example of a storage device, stores setting information and a program for the operation of the CPU 700.

The floppy disk drive 712 reads data or a program from a floppy disk 720 to provide the read data or program to the CPU 700. The CD-ROM drive 714 reads data or a program from a CD-ROM 722 to provide the read data or program to the CPU 700. The communication interface 706 can be connected to the network administration apparatus so as to perform data transmission and data receiving. The database interface 710 can be connected to the various databases 724 so as to perform data transmission and data receiving.

Software executed by the CPU 700 is provided to a user while being stored in a recording medium such as the floppy disk 720 or the CD-ROM 722. The software stored in the recording medium may be compressed or not-compressed. The software is installed from the recording medium into the hard disk drive 708, and is then read into the RAM 704 so that the CPU 700 executes the software.

The software provided while being stored in the recording medium, that is the software to be installed into the hard disk drive 708, functionally includes a receiving module, a storing module, a transmitting module, a judging module and a detecting module. Operations that are to be executed by the CPU 700 in accordance with instructions of the respective modules to the computer are the same as the functions and operations of the corresponding components in the node detecting apparatus 10 of the present embodiment, respectively, and therefore the description thereof is omitted.

A part or all of the functions and operations of the node administration apparatus 10 according to all the embodiments described in the present application can be stored in the floppy disk 720 or the CD-ROM 722 shown in FIG. 6 as an example of the recording medium.

These programs may be read directly into the RAM from the recording medium, or read into the RAM after being installed into the hard disk drive from the recording medium. Moreover, the above-mentioned programs may be stored in a single recording medium or a plurality of recording media. Furthermore, the programs may be stored while being encoded.

As the recording medium, other than the floppy disk and the CD-ROM, an optical recording medium such as a DVD or a PD, a magneto-optical recording medium such as an MD, a tape-like medium, a magnetic recording medium, or a semiconductor memory such as an IC card or a miniature card can be used. Moreover, a storage device such as a hard disk or a RAM provided in a server system connected to an exclusive communication network or the Internet may be used as the recording medium, so that the program can be provided to the node detecting apparatus 10 through the communication network or the Internet. Such a recording medium is used only for manufacturing the node detecting apparatus 10 and it is therefore apparent that manufacturing or selling such a recording medium as business can constitute infringement of the right based on the present application.

As is apparent from the above description, according to the present invention, a node detecting method that allows precise detection of information of a node that is a device included in a computer network can be provided.

Although the present invention has been described by way of exemplary embodiments, it should be understood that those skilled in the art might make many changes and substitutions without departing from the spirit and the scope of the present invention which is defined only by the appended claims.

1. A node detecting method for detecting a node that operates as a device in a computer network, comprising:
a first transmitting step of transmitting a first detection signal to said node;
a first receiving step of receiving, from said node that received said first detection signal, address information of said node;
a first storing step of storing in a first memory said address information of said node received in said first receiving step;
a second transmitting step of transmitting a second detection signal to said node by using said address information of said node stored in said first memory;
a second receiving step of receiving, from said node that received said second detection signal, classification information of said node in response to said second detection signal;
a judging step of judging a classification of said node based on said classification information of said node received in said second receiving step; and
a second storing step of storing said classification information of said node in a second memory to correspond to said classification of said node.

2. A node detecting method as claimed in claim 1, wherein
said first transmitting step includes transmitting an ICMP echo message as said first detection signal to a plurality of nodes by using a broadcast address of a predetermined subnet,
said first receiving step includes receiving, from at least one of said plurality of nodes that responds to said ICMP echo message, an IP address thereof as said address information, and
said first storing step includes storing said IP address of said at least one node.

3. A node detecting method as claimed in claim 1, wherein
said second transmitting step includes transmitting an ICMP echo message as said second detection signal to said node based upon said address information stored in said first memory,
said second receiving step includes receiving, from said node that responds to said ICMP echo message, an IP address of said node as said classification information,
said judging step includes judging that said node that sent said IP address is an IP node, and
said second storing step includes storing said node as the IP node to correspond to said IP address.

4. A node detecting method as claimed in claim 1, wherein
said second transmitting step includes transmitting an ICMP echo message as said second detection signal to said node stored in said first memory,
said first receiving step includes receiving from said node an MAC address of said node,
said judging step includes judging that said node that received said ICMP echo message is a MAC node when there is no response from said node that received said ICMP echo message, and
said second storing step includes storing said node as the MAC node to correspond to said MAC address.

5. A node detecting method as claimed in claim 3, wherein
said second transmitting step further includes transmitting a detection signal according to an SNMP protocol to said node based upon said address information stored in said first memory,
said second receiving step includes receiving, from said node that received said detection signal according to said SNMP protocol, SNMP information of said node,
said judging step includes judging that said node that sent said SNMP information is an SNMP node, and
said second storing step includes storing said node as the SNMP node to correspond to said SNMP information.

6. A node detecting method as claimed in claim 5, wherein
said judging step includes judging based on said SNMP information whether or not said node is an interconnecting device, and
said second storing step includes storing said node as an interconnecting node to correspond to said SNMP information, when said node is judged to be said interconnecting device in said judging.

7. A node detecting method a claimed in claim 6, further comprising:
a third receiving step of receiving, from said interconnecting node, port identifying information for identifying a port of said interconnecting node and node identifying information of a node connected to said port; and
a third storing step of storing said node identifying information of said node connected to said port in said second memory to correspond to said port identifying information of said port to which said node is connected.

8. A node detecting method as claimed in claim 7, wherein in a case where said interconnecting node has a stack connection,
said third receiving step includes receiving, from said interconnecting node, stack identifying information for identifying a stack of said interconnecting node and said node identifying information of said node connected to said stack, and
said third storing step includes storing said node identifying information of said node connected to said stack in said second memory to correspond to said stack identifying information received in said third receiving step.

9. A node detecting method as claimed in claim 7, wherein in a case where a VLAN group is set to said port of said interconnecting node,
said third receiving step includes receiving, from said interconnecting node, VLAN identifying information for identifying said VLAN group and said node identifying information for identifying said node that belongs to said VLAN group, and
said third storing step includes storing said node identifying information of said node that belongs to said VLAN group in said second memory to correspond to said VLAN identifying information received in said third receiving step.

10. A node detecting method as claimed in claim 6, further comprising:
a third receiving step of receiving address information of a node connected to said interconnecting node from said interconnecting node;
a third storing step of storing in said first memory said address information of said node received in said third receiving step; and
repeating said second transmitting step, said second receiving step, said judging step, said second storing step, said third receiving step and said third storing step for said node connected to said interconnecting node.

11. A node detecting method as claimed in claim 10, wherein, in said third storing step, node identifying information of said node connected to said interconnecting node is stored in said second memory to correspond to said interconnecting node.

12. A node detecting method as claimed in claim 11, further comprising:
determining a weight of a node being detected in advance depending on said classification of said node being detected,
comparing a first weight of said node being detected having said classification based upon said classification information received in said second receiving step and a second weight of said node being detected having a previous classification stored in said second memory,
merging node identifying information of said node having less weight based upon said comparing into node identifying information of said node having more weight, and
storing said merged node identifying information in said second memory to correspond to said classification of said node having more weight.

13. A node detecting method as claimed in claim 12, wherein said weight is determined in such a manner that said weight corresponding to each of said MAC node, said IP node, said SNMP node and said interconnecting node increases in that order.

14. A node detecting apparatus for detecting a node that operates as a device in a computer network, comprising:
a transmitting unit operable to transmit a first detection signal to said node;
a receiving unit operable to receive, from said node that received said first detection signal, address information of said node;
a first memory operable to store said address information of said node received by said receiving unit;
a judging unit operable to transmit a second detection signal to said node based on said address information of said node stored in said first memory, and to judge, in a case where classification information of said node is received from said node in response to said second detection signal, a classification of said node based on said classification information of said node; and
a second memory operable to store said classification information of said node to correspond to said classification of said node.

15. A node detecting program for detecting a node that operates as a device in a computer network, comprising:
a transmitting module operable to transmit a first detection signal to said node;
a receiving module operable to receive, from said node that received said first detection signal, address information of said node;
a first storing module operable to store said received address information of said node;
a judging module operable to transmit a second detection signal to said node based on said address information of said node stored in said first memory, and to judge, in a case where classification information of said node is received from said node in response to said second detection signal, a classification of said node based on said classification information of said node; and
a second storing module operable to store said classification information of said node to correspond to said classification of said node.
